(19) United States
(12) Patent Application Publication
(10) Pub. No.: US 2011/0299276 A1
(43) Pub. Date: Dec. 8, 2011

(54) LED LIGHT TUBE

(75) Inventor: YUEH-CHENG LEE, TAIPEI COUNTY (TW)

(73) Assignee: VINCENC LED LIGHTING CORP., TAIPEI HSIEN (TW)

(21) Appl. No.: 12/842,322

(22) Filed: Jul. 23, 2010

(30) Foreign Application Priority Data
Jun. 8, 2010 (CN) 201020218377.1

(51) Int. Cl. F21V 29/00

(52) U.S. Cl. 362/218

(57) ABSTRACT

An LED light tube includes a tube, an LED light module, two end caps and a starter, wherein the tube includes a board and a transparent cover which is mounted to the board. The LED light module is connected to the board by fixing a circuit board thereof to the board and two reflection plates are connected to the board. The two end caps are connected to the two ends of the tube and the starter is hidden in one of the two end caps. The board includes heat dispensing fins to quickly release the heat from the LEDs on the circuit board and the reflection plates increase the illumination of the light tube.

### FIELD OF THE INVENTION

The present invention relates to a Light Emitting Diodes (LED hereinafter) light tube, and more particularly, to an LED light tube having heat dispensing fins and the starter is hidden.

### BACKGROUND OF THE INVENTION

LEDs are developed for years and the techniques for manufacturing is improved so that the LEDs are compact, less energy consuming, more green to the environment, longer service period and high illumination. The LEDs are used widely in different areas and replace the conventional fluorescent tubes.

FIG. 1 shows a conventional LED light tube and generally includes an elongate and hollow tube 10 which is made of transparent material and has two open ends. An LED light module 20 which has a circuit board 201 and multiple LEDs connected to the circuit board 201. Two end caps 30 are connected to the two open ends of the tube 10 and each have two contact terminals 301. A starter 40 is located in one of the end caps 30 and electrically connected to the circuit board 201. The starter 40 can also be installed to the interior of the tube 10 as shown in FIG. 2. The contact terminals 301 are connected with the reception holes of the light unit which is not shown and the current goes through the starter 40 to activate the LEDs 202.

The conventional LED light tubes has some shortcomings, one of which is that the starter is hidden in the end cap as shown in FIG. 4, although the arrangement meet the aesthetic requirement, the length of the light tube becomes too long and the size becomes bulky. The distance between the light tube to the reception sockets of the light unit increases and may cause the light tube to be unstable. The second shortcoming is that if the starter is located in the tube, the starter can be seen via the transparent tube and this makes the tube to be sort of ugly. The third shortcoming is that how the illumination performs is dependent upon how much the current is provided, and the higher current is provided, the more heat is generated which affects the function of the LEDs. The conventional LED tubes do not have proper heat dispensing function and the heat reduces the term of use of the LED tube.

The present invention intends to provide an LED light tube which includes heat dispensing fins and the starter is well positioned to improve the shortcomings of the conventional LED light tubes and

### SUMMARY OF THE INVENTION

The present invention relates to an LED light tube which comprises a tube comprising a board and a cover. The board is an aluminum extruding product and has two connection slots defined in two sides thereof and the two engaging slots defined in a first surface thereof. Multiple heat dispensing fins extend from a second surface of the board. The cover is made of transparent material and has two flanges on two sides thereof. The two flanges are engaged with the two connection slots of the board. An LED light module comprises a circuit board and multiple LEDs are connected to the circuit board. The circuit board is connected to the first surface of the board and the LEDs face the cover. Two end caps are respectively connected to two ends of the tube and each comprise a case and an end piece. The case has a radial wall located therein and multiple holes are defined through the radial wall. A starter is located in the case and has two first wires which extend through the holes and are electrically connected to the circuit board of the LED light module. The end pieces are connected to the cases respectively and each have contact terminals which are electrically connected to the starter by second wires via the holes.

The radial wall of each case includes ribs and a curved protrusion extending toward the board. The heat dispensing fins are engaged with gaps between the ribs and an end of the cover is positioned by the curved protrusion.

The circuit board of the LED light module is fixed to the board and two reflection plates are connected to the first surface of the board. The reflection plates cover the engaging slots and the second wires in the engaging slots.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional LED light tube;

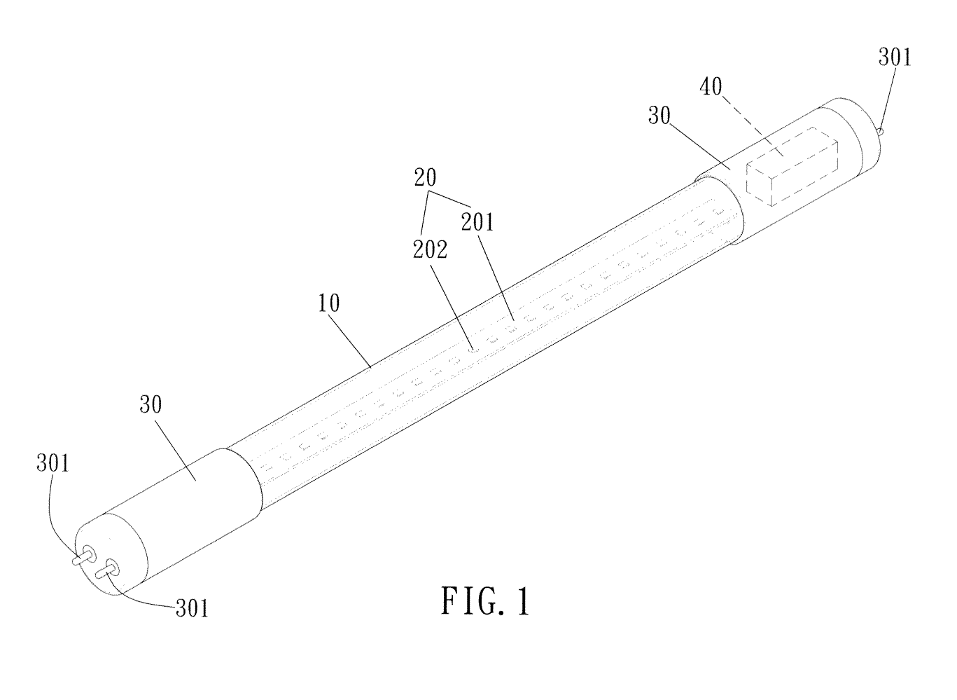

FIG. 2 shows another conventional LED light tube;

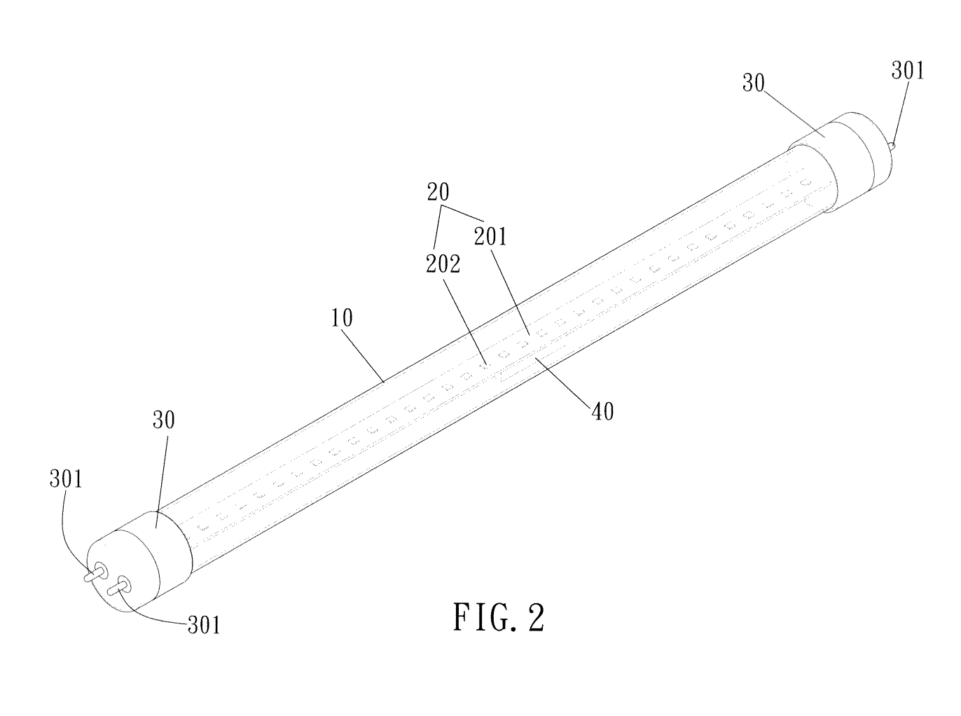

FIG. 3 is an exploded view to show the LED light tube of the present invention;

FIG. 4 is a perspective view to show the LED light tube of the present invention;

FIG. 5 is a plan view of the LED light tube of the present invention, and

FIG. 6 is a cross sectional view of the LED light tube of the present invention.

### DETAILED DESCRIPTION OF THE PREFERRED EMBODIMENT

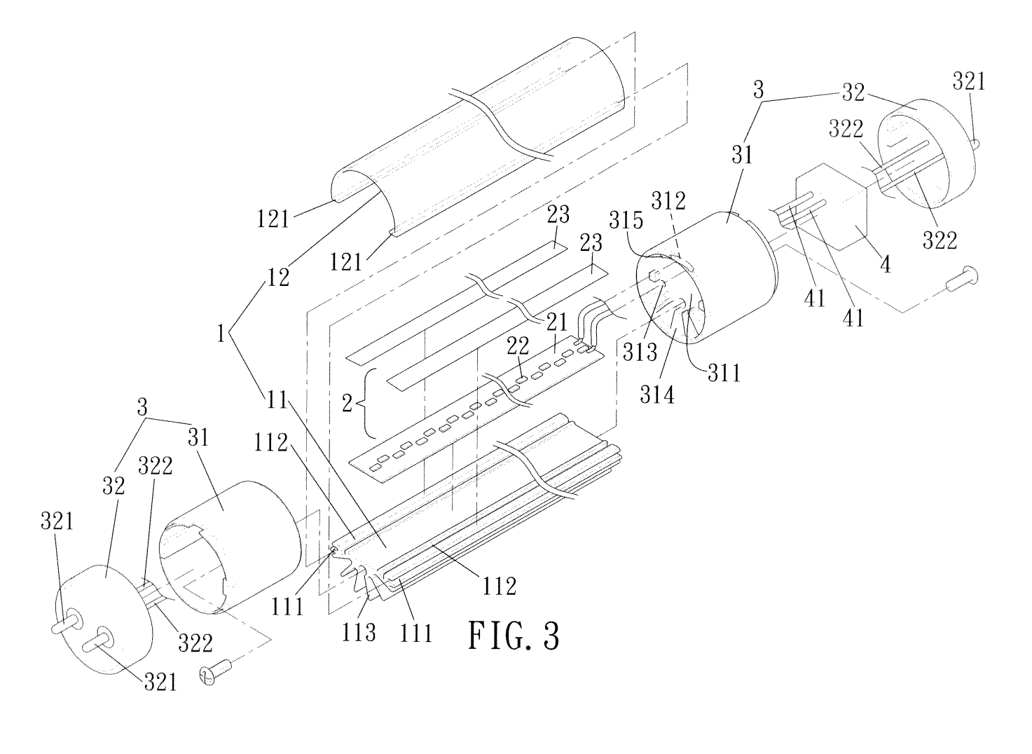

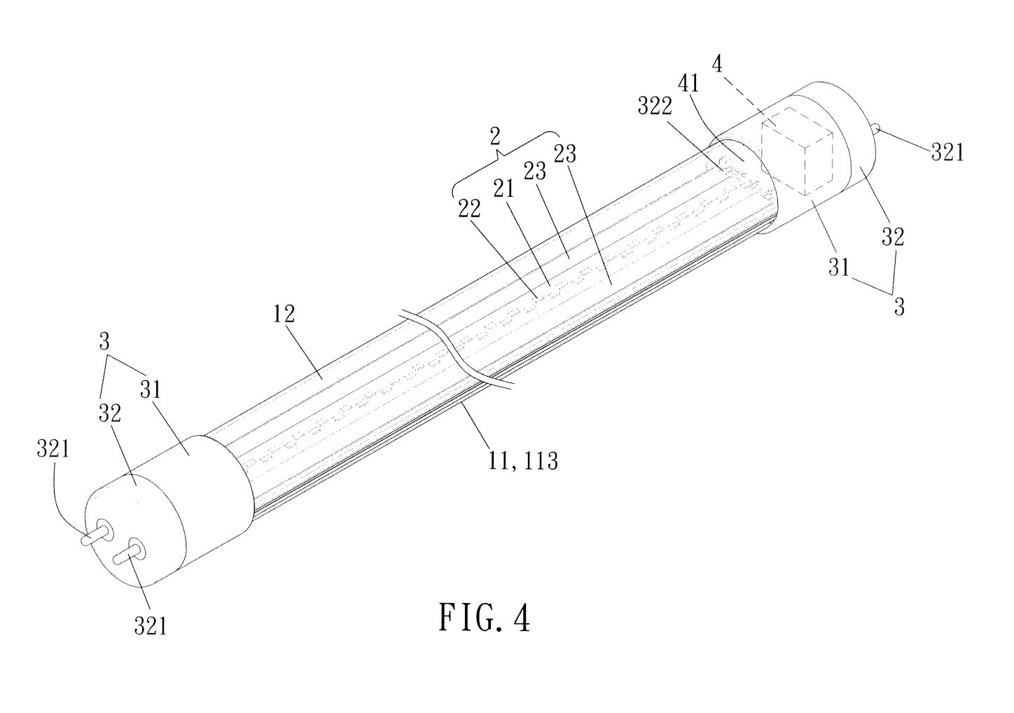

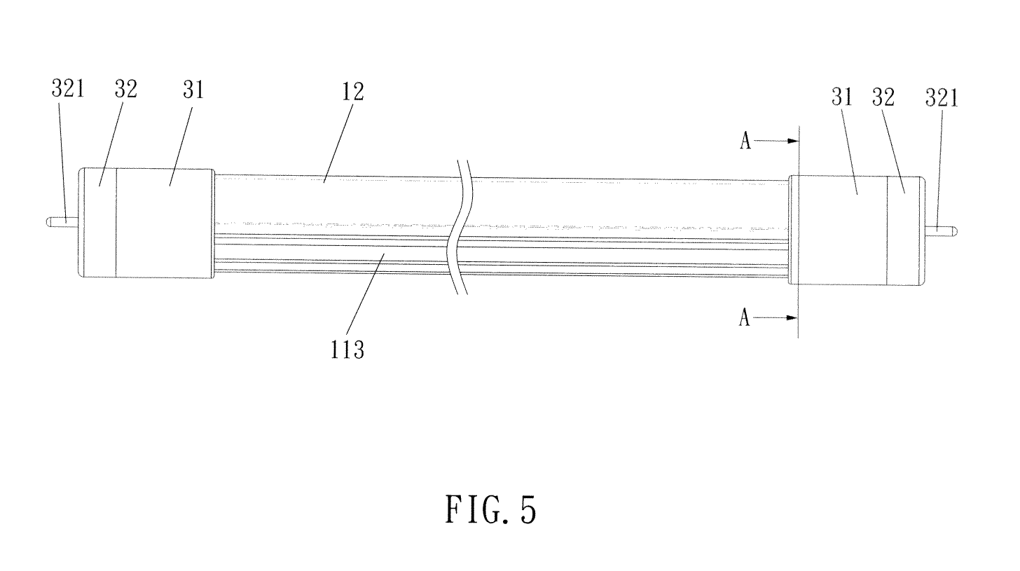

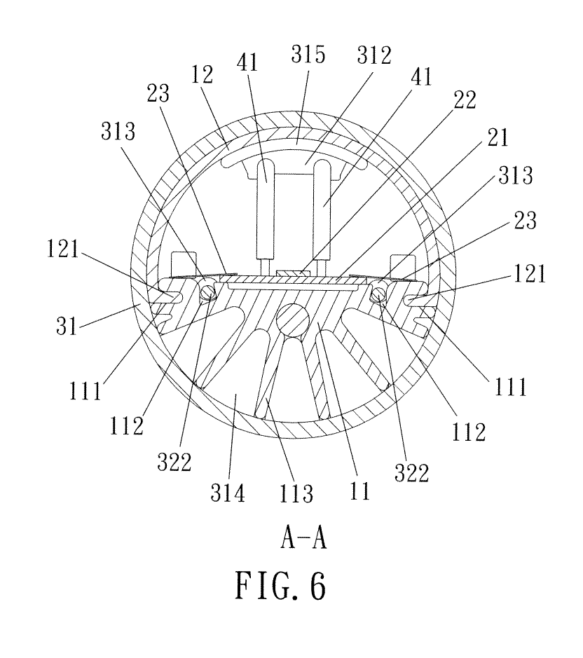

Referring to FIGS. 3 to 6, the LED light tube of the present invention comprises a tube 1, an LED light module 2, two end caps 3 and an LED starter 4. The tube 1 comprises a board 11 and a cover 12. The board 11 is an aluminum extruding product and has two connection slots 111 defined in two sides thereof and the two engaging slots 112 defined in a first surface thereof. Multiple heat dispensing fins 113 extend from a second surface of the board 11. The cover 12 is made of transparent material and has two flanges 121 on two sides thereof, the two flanges 121 are engaged with the two connection slots 111 of the board 11.

The LED light module 2 comprises a circuit board 21 and multiple LEDs 22 are connected to the circuit board 21. The circuit board 21 is connected to the first surface of the board 11 and the LEDs 22 face the cover 12. The LEDs are located alternatively along two parallel axes so as to increase the illumination of the light tube. The LED light module 2 further comprises two reflection plates 23 are connected to the first surface of the board 11. The reflection plates 23 cover the engaging slots 112.

The two end caps 3 are respectively connected to two ends of the tube 1 and each comprise a case 31 and an end piece 32. The case 31 has a radial wall 311 located therein and multiple holes 312, 313 are defined through the radial wall 311. The starter 4 is located in one of the cases 31 and has two first wires 41 which extend through the holes 312 and are electrically connected to the circuit board 21 of the LED light module 2. The end pieces 32 are connected to the cases 31 respectively and each have two contact terminals 321 which are electrically connected to the starter 4 by second wires 322 via the holes 313. The reflection plates 23 also cover the second wires 322 in the engaging slots 112.

The radial wall 311 of each case 31 includes ribs 314 and a curved protrusion 315 extending toward the board 11 respectively. The heat dispensing fins 113 are engaged with gaps between the ribs 314 and an end of the cover 12 is positioned by the curved protrusion 315.

The starter 4 is compact and can be received in the cap 3 so that the total length of the light tube is not too long and the distance between the starter 4 and the board 11 is shortened.

The starter 4 is well hidden in the end cap 3 so that it is not visible via the transparent cover 12. This arrangement makes the light tube to meet aesthetic requirements. The heat dispensing fins 113 extend radially and form a style of fashion.

The circuit board 21 is directly adhered to the board 11 so that the heat generated from the LEDs 22 is directly released to the air.

The two reflection plates are adhered to the board 11 to increase the illumination of the light tube, and the reflection plates 23 cover the engaging slots 112 and the second wires 322 in the engaging slots 112.

While we have shown and described the embodiment in accordance with the present invention, it should be clear to those skilled in the art that further embodiments may be made without departing from the scope of the present invention.

What is claimed is:

1. An LED light tube comprising:
a tube comprising a board and a cover, the board being an aluminum extruding product and having two connection slots defined in two sides thereof and the two engaging slots defined in a first surface thereof, multiple heat dispensing fins extending from a second surface of the board, the cover being made of transparent material and having two flanges on two sides thereof, the two flanges engaged with the two connection slots of the board;
an LED light module comprising a circuit board and multiple LEDs connected to the circuit board, the circuit board connected to the first surface of the board and the LEDs facing the cover, and
two end caps respectively connected to two ends of the tube and each comprising a case and an end piece, the case having a radial wall located therein and multiple holes defined through the radial wall, a starter located in the case and having two first wires which extend through the holes and are electrically connected to the circuit board of the LED light module, the end pieces connected to the cases respectively and each have contact terminals which are electrically connected to the starter by second wires via the holes.

2. The LED light tube as claimed in claim 1, wherein the radial wall of each case includes ribs and a curved protrusion extending toward the board respectively, the heat dispensing fins are engaged with gaps between the ribs and an end of the cover is positioned by the curved protrusion.

3. The LED light tube as claimed in claim 1, wherein the circuit board of the LED light module is fixed to the board and two reflection plates are connected to the first surface of the board, the reflection plates cover the engaging slots and the second wires in the engaging slots.
